(19) United States
(12) Patent Application Publication
(10) Pub. No.: US 2023/0091985 A1
(43) Pub. Date: Mar. 23, 2023

(54) METHOD AND DEVICE FOR MEASURING CUTTING FORCE, ELECTRONIC APPARATUS AND STORAGE MEDIUM

(71) Applicant: TSINGHUA UNIVERSITY, Beijing (CN)

(72) Inventors: SHAN-SHAN KANG, Beijing (CN); PING-FA FENG, Beijing (CN); XIAO-QIANG TANG, Shenzhen (CN); LI LIU, Beijing (CN); LI WANG, Beijing (CN); HAI-LIN BAI, Beijing (CN)

(21) Appl. No.: 17/947,165

(22) Filed: Sep. 18, 2022

(30) Foreign Application Priority Data
Sep. 18, 2021 (CN) 202111101687.4

(51) Int. Cl. B23Q 17/09

(52) U.S. Cl. CPC B23Q 17/0961

(57) ABSTRACT

The disclosure provides a method and a device for measuring a cutting force, an electronic apparatus and a storage medium. The method includes: obtaining first cutting force data of a cutter of a craft equipment, first torque data of a first servo motor, and second torque data of a second servo motor in a case that the cutting force of the craft equipment is detected to be in a stable state; generating first cutting force compensation data based on a first torque mapping coefficient and the first torque data; generating second cutting force compensation data based on a second torque mapping coefficient and the second torque data; and correcting the first cutting force data based on the first cutting force compensation data and the second cutting force compensation data to obtain target cutting force data.

### CROSS-REFERENCE TO RELATED APPLICATION

The present application claims the priority of Chinese patent application No. 202111101687.4, filed on Sep. 18, 2021, and entitled “Method and Device for Measuring Cutting Force, Electronic Apparatus and Storage Medium”, the entire content of which is hereby incorporated by reference in its entirety.

### TECHNICAL FIELD

The present disclosure relates to the technical field of information processing, in particular, to a method and a device for measuring cutting force, an electronic apparatus, and a storage medium.

### BACKGROUND

Measurement of cutting force has always been a key research content in the field of processing by the cutting machine tool. In the actual production process, for different processing technologies, materials, and methods, the entire cutting and machining process may be intuitively reflected by the measurement of cutting force, which plays an important guiding role in optimizing cutting parameters, reducing wear of the cutter, and improving processing quality and cutting efficiency.

### SUMMARY

The present disclosure provides a method and a device for measuring a cutting force, an electronic apparatus, and a storage medium.

The present disclosure provides a method for measuring a cutting force, including following steps.

First cutting force data of a cutter of a craft equipment, first torque data of a first servo motor, and second torque data of a second servo motor are obtained in a case that the cutting force of the craft equipment is detected to be in a stable state. The first servo motor is configured to drive a workpiece to rotate, and the second servo motor is configured to drive the cutter of the craft equipment to contact the workpiece.

First cutting force compensation data is generated based on a first torque mapping coefficient and the first torque data. Second cutting force compensation data is generated based on a second torque mapping coefficient and the second torque data. The first torque mapping coefficient and the second torque mapping coefficient are generated according to multiple sets of second cutting force data of the cutter of the craft equipment and multiple sets of third torque data of the first servo motor and multiple sets of fourth torque data of the second servo motor. The multiple sets of second cutting force data of the cutter of the craft equipment, the multiple sets of third torque data of the first servo motor, and the multiple sets of fourth torque data of the second servo motor are obtained in a case that the cutting force of the cutter of the craft equipment is in a changing state. The first cutting force data is cutting force data when the cutting force of the cutter of the craft equipment is in the stable state, the second cutting force data is cutting force data when the cutting force of the cutter of the craft equipment is in the changing state, and the cutting force data includes main cutting force data, radial thrust force data, and axial thrust force data.

The first cutting force data is corrected based on the first cutting force compensation data and the second cutting force compensation data to obtain target cutting force data.

According to the method for measuring the cutting force of the present disclosure, before the obtaining the first cutting force data of the cutter of the craft equipment, the first torque data of the first servo motor, and the second torque data of the second servo motor, the method further includes following steps.

A variation of the cutting force data of the cutter of the craft equipment is obtained.

It is determined that the cutting force of the cutter of the craft equipment is in the changing state in a case that the variation of the cutting force data is not less than a preset threshold.

Or, it is determined that the cutting force of the cutter of the craft equipment is in the stable state in a case that the variation of the cutting force data is less than a preset threshold.

According to the method for measuring the cutting force of the present disclosure, after the determining that the cutting force of the cutter of the craft equipment is in the changing state in the case that the variation of the cutting force data is not less than the preset threshold, the method further includes following steps.

Multiple measured data sets are obtained in the case that the cutting force of the cutter of the craft equipment is in the changing state, each of the multiple measured data sets includes the second cutting force data of the cutter of the craft equipment, the third torque data of the first servo motor, and the fourth torque data of the second servo motor.

The first torque mapping coefficient is determined based on the second cutting force data and the third torque data in each of the multiple measured data sets.

The second torque mapping coefficient is determined based on the second cutting force data and the fourth torque data in each of the multiple measured data sets.

According to the method for measuring the cutting force of the present disclosure, the determining the first torque mapping coefficient based on the second cutting force data and the third torque data in each of the multiple measured data sets includes following steps.

Multiple sets of third torque mapping coefficients are determined according to the third torque data, and the second main cutting force data and the second radial thrust force data of the second cutting force data in each of the multiple measured data sets.

A calculation of least squares fitting is performed for the multiple sets of third torque mapping coefficients to obtain the first torque mapping coefficient.

According to the method for measuring the cutting force of the present disclosure, the determining the second torque mapping coefficient based on the second cutting force data and the fourth torque data in each of the multiple measured data sets includes following steps.

Multiple sets of fourth torque mapping coefficients are determined according to the fourth torque data and the second axial thrust force data of the second cutting force data in each of the multiple measured data sets.

A calculation of least squares fitting is performed for the multiple sets of fourth torque mapping coefficients to obtain the second torque mapping coefficient.

According to the method for measuring the cutting force of the present disclosure, the first cutting force data includes first main cutting force data, first radial thrust force data and first axial thrust force data, and the correcting the first cutting force data based on the first cutting force compensation data and the second cutting force compensation data to obtain the target cutting force data includes following steps.

The first main cutting force data is corrected based on main cutting force compensation data in the first cutting force compensation data to obtain target main cutting force data.

The first radial thrust force data is corrected based on radial thrust force compensation data in the first cutting force compensation data to obtain target radial thrust force data.

The first axial thrust force data is corrected based on the second cutting force compensation data to obtain target axial thrust force data.

The target cutting force data is obtained according to the target main cutting force data, the target radial thrust force data, and the target axial thrust force data.

The present disclosure provides a device for measuring cutting force, including an acquisition unit, a compensation unit, and a correcting unit.

The acquisition unit is configured to obtain first cutting force data of a cutter of a craft equipment, first torque data of a first servo motor, and second torque data of a second servo motor in a case that the cutting force of the craft equipment is detected to be in a stable state. The first servo motor is configured to drive a workpiece to rotate, and the second servo motor is configured to drive the cutter of the craft equipment to contact the workpiece;

The compensation unit is configured to generated first cutting force compensation data based on a first torque mapping coefficient and the first torque data, generate second cutting force compensation data based on a second torque mapping coefficient and the second torque data. The first torque mapping coefficient and the second torque mapping coefficient are generated according to multiple sets of second cutting force data of the cutter of the craft equipment and multiple sets of third torque data of the first servo motor and multiple sets of fourth torque data of the second servo motor. The multiple sets of second cutting force data of the cutter of the craft equipment, the multiple sets of third torque data of the first servo motor, and the multiple sets of fourth torque data of the second servo motor are obtained in a case that the cutting force of the cutter of the craft equipment is in a changing state. The first cutting force data is cutting force data when the cutting force of the cutter of the craft equipment is in the stable state, the second cutting force data is cutting force data when the cutting force of the cutter of the craft equipment is in the changing state, and the cutting force data includes main cutting force data, radial thrust force data, and axial thrust force data.

The correcting unit is configured to correct the first cutting force data based on the first cutting force compensation data and the second cutting force compensation data to obtain target cutting force data.

The present disclosure provides an electronic apparatus, including a memory, a processor, and a computer program stored on the memory and executable in the processor. The processor, when executing the computer program, performs steps of any method for measuring the cutting force above.

The present disclosure provides a non-transitory computer-readable storage medium, on which a computer program is stored. The computer program, when being executed by a processor, causes the processor to perform steps of any method for measuring the cutting force above.

The present disclosure provides a computer program product, including a computer program. The computer program, when being executed by a processor, causes the processor to perform steps of any method for measuring the cutting force above.

In the method and the device for measuring cutting force, the electronic apparatus and the storage medium provided by the present disclosure, based on the fact that the piezoelectric sensor is sensitive to the increase in the force, in the case that the cutting force of the craft equipment is detected to be in the stable state, by detecting the shaft torque data of each servo motor, and according to the physical mapping relationship between the cutting force of the cutter and the shaft torque of each servo motor, the measured cutting force data and the torque data of the servo motor are coupled and solved to determine the first torque mapping coefficient and the second torque mapping coefficient that are numerically reliable. Thus, based on the first cutting force data of the cutter of the craft equipment and the first torque data of the first servo motor and the second torque data of the second servo motor, which are obtained in the case that the craft equipment cutting force is in the stable state, the actual first cutting force compensation data may be obtained according to the first torque mapping coefficient and the first torque data, and the actual second cutting force compensation data is obtained according to the second torque mapping coefficient and the second torque data. And then, based on the first cutting force compensation data and the second cutting force compensation data, the first cutting force data actually measured in the stable state is corrected to obtain the accurate and real cutting force, thereby improving the measurement accuracy of the cutting force data in the stable state, which is beneficial to optimization of the cutting process, thereby improving the working efficiency of the cutting machine tool.

### BRIEF DESCRIPTION OF THE DRAWINGS

In order to illustrate the technical solutions in the present disclosure or the prior art more clearly, the accompanying drawings needed in the description of the embodiments or the prior art will be briefly introduced hereinafter. Obviously, the accompanying drawings described hereinafter are some embodiments of the present disclosure, for those of ordinary skill in the art, other drawings may also be obtained according to these drawings without any creative efforts.

FIG. 1 is a schematic structural view showing an overall system for measuring a cutting force provided by the present disclosure.

FIG. 2 is a schematic flowchart of a method for measuring a cutting force provided by the present disclosure.

FIG. 3 is a schematic view showing a distribution of the cutting force of a cutter of a craft equipment provided by the present disclosure.

FIG. 4 shows schematic flowcharts of compensating and correcting the cutting force provided by the present disclosure.

FIG. 5 is a schematic structural view showing a device for measuring a cutting force provided by the present disclosure.

FIG. 6 is a schematic structural view showing an electronic apparatus provided by the present disclosure.

### DETAILED DESCRIPTION OF THE EMBODIMENTS

Currently, in an existing cutting force measurement system, a dynamometer is usually used to measure the cutting force, and there is a problem that the measurement accuracy of the cutting force signal is not high.

Therefore, how to measure the cutting force better has become an urgent problem to be solved in the industry.

To make the objectives, technical solutions and advantages of the present disclosure clearer, the technical solutions of the present disclosure will be described clearly and completely by combining the accompanying drawings in the present disclosure. Obviously, the described embodiments are part of but not all of the embodiments of the present disclosure. Based on the embodiments of the present disclosure, all other embodiments obtained by those of ordinary skill in the art without creative efforts shall fall within the protection scope of the present disclosure.

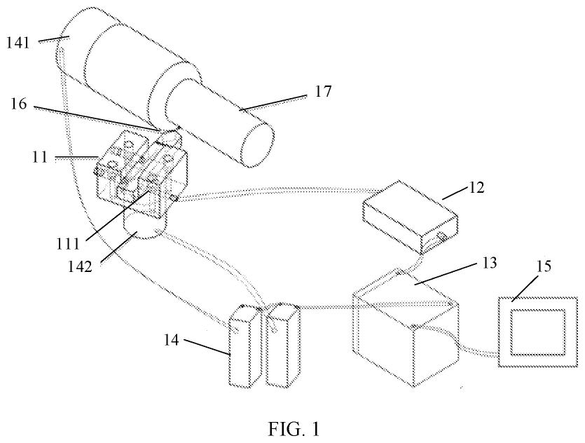

A method and a device for measuring a cutting force, an electronic apparatus, and a storage medium provided by the present disclosure will be described hereinafter with reference to FIG. 1 to FIG. 6.

It should be noted that, in the prior art, a piezoelectric sensor is often used to acquire cutting force data. However, due to the defect of charge leakage in piezoelectric materials, the piezoelectric sensor is only sensitive to an increase in force, thus resulting in low measurement accuracy of the cutting force signal measured by the sensor in the stable state.

FIG. 1 is a schematic structural view showing an overall system for measuring a cutting force provided by the present disclosure. As shown in FIG. 1, a piezoelectric sensor 111 is installed inside a craft equipment 11. A cutter 16 is fixed on a cutter magazine worktable of the craft equipment 11 by a clamp. The piezoelectric sensor 111, by means of a charge amplifier 12, amplifies a tiny electrical signal to be from minus 10V to plus 10V. A high-frequency analog-to-digital (AD) conversion module in a controller 13 performs oversampling to convert an amplified analog signal into a digital signal. Data are processed by the controller 13 to consolidate the oversampled data, signal noise points are filtered by a Kalman filtering method, and a cutting force signal graph is outputted to and displayed on the computer 15. A servo motor driver pack 14 is connected to a spindle motor 141 and drives the spindle motor to operate to drive a workpiece 17 to rotate at a high speed. The servo motor driver pack 14 is connected to the Z-directional feed motor 142, and configured to drive the Z-directional feed motor 142 to operate to drive the cutter 16 fixedly connected with the craft equipment to move in the Z direction and contact and cut the workpiece 17 rotating at a high speed. The servo motor driver pack 14 and the controller 13 are connected by an Ethernet control automation technology (Ether CAT) bus. By setting parameters of a process data object (PDO), a shaft torque of the spindle motor 141 and a shaft torque of the Z-directional feed motor 142 are detected in real time. The cutting force data and the torque data are coupled and solved by the controller 13 to compensate and correct the cutting force data in the stable state. The computer 15 is connected to the controller 13, and configured to display and operate.

FIG. 2 is a schematic flowchart of a method for measuring a cutting force provided by the present disclosure, and an executing body of the method may be a controller in a device for measuring a cutting force of the present disclosure. As shown in FIG. 2, the method includes steps S1 to S3.

At step S1, in a case that a cutting force of the craft equipment is detected to be in a stable state, first cutting force data of a cutter of the craft equipment, first torque data of a first servo motor, and second torque data of a second servo motor are obtained. The first servo motor is configured to drive a workpiece to rotate, and the second servo motor is configured to drive the cutter of the craft equipment to contact the workpiece.

In some embodiments, the first servo motor described in the present disclosure refers to the spindle motor configured to drive the workpiece to rotate.

The second servo motor described in the present disclosure refers to the Z-directional feed motor configured to drive the cutter of the craft equipment to move in the Z direction.

In the embodiment of the present disclosure, the first servo motor drives the workpiece to rotate at a high speed, and when the second servo motor drives the cutter of the craft equipment to move in the Z direction and contact the high-speed rotating workpiece, a cutting force of high-speed cutting will be generated on the cutter of the craft equipment, and by decomposing the cutting force in a three-dimensional space, component forces of the cutting force in three directions, namely a main cutting force, a radial thrust force, and an axial thrust force are obtained. A piezoelectric sensor system is arranged inside the craft equipment. The piezoelectric sensor system is configured to acquire the cutting force exerted on the cutter of the craft equipment, and output a voltage signal correspondingly. The voltage signal is amplified and processed by an analog-digital conversion through a high-frequency AD module to obtain the cutting force data, thereby realizing the measurement of the cutting force of the cutter of the craft equipment.

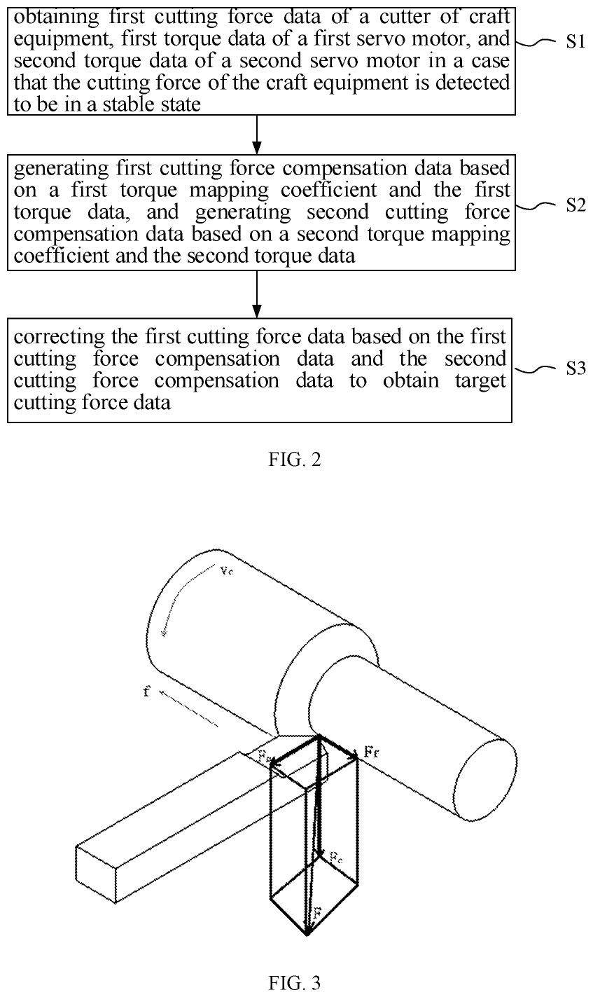

FIG. 3 is a schematic view showing a distribution of the cutting force of the cutter of the craft equipment provided by the present disclosure. As shown in FIG. 3, exemplarily, taking cutting an outer circle as an example, and ignoring a cutting effect of an auxiliary cutting edge and other influencing factors, the first servo motor drives the workpiece to rotate at a high speed of a rotational speed V_{c}. The resultant force F is in a main section of the cutter and is divided into three component forces perpendicular to each other. Fc denotes the main cutting force, which is consistent with the direction of the main cutting speed. Fₚ denotes the radial thrust force, which is in a base plane and perpendicular to the Z-directional feeding direction of the movement of the cutter driven by the second servo motor. F_{f} denotes the axial thrust force, which is in the base plane and parallel to the feeding direction of the cutter.

The cutting force of the cutter of the craft equipment described in the present disclosure being in the stable state means that the cutting force of the cutter of the craft equipment at a certain time point is approximately equal to the cutting force at a previous time point of the certain time point, and in a case that a difference between the two cutting forces is less than a preset threshold, it is determined that the cutting force of the cutter of the craft equipment at the certain time point is in the stable state, and the cutting force at this time may also be called a cutting force partial to static state.

The first cutting force data described in the present disclosure refers to the cutting force data of the cutter of the craft equipment obtained when the cutting force of the cutter of the craft equipment is in the stable state, and the cutting force data of the cutter of the craft equipment includes the cutting force data in three directions of the high-speed cutting on the cutting machine tool, namely the main cutting force data, the radial thrust force data and the axial thrust force data.

The first torque data of the first servo motor described in the present disclosure refers to shaft torque data of the first servo motor obtained in real time in the case that the cutting force of the cutter of the craft equipment is in the stable state.

The second torque data of the second servo motor described in the present disclosure refers to shaft torque data of the second servo motor obtained in real time in the case that the cutting force of the cutter of the craft equipment is in the stable state.

At step S2, first cutting force compensation data is generated based on a first torque mapping coefficient and the first torque data, and second cutting force compensation data is generated based on a second torque mapping coefficient and the second torque data. The first torque mapping coefficient and the second torque mapping coefficient are generated according to multiple measured data sets, and each set of the multiple measured data sets includes the second cutting force data of the cutter of the craft equipment, the third torque data of the first servo motor, and the fourth torque data of the second servo motor. The second cutting force data of the cutter of the craft equipment, the third torque data of the first servo motor, and the fourth torque data of the second servo motor are obtained in the case that the cutting force of the cutter of the craft equipment is in a changing state.

In some embodiments, due to the dynamic characteristics of the piezoelectric sensor, the piezoelectric sensor is sensitive to an increase in force. Therefore, in the case that the cutting force of the cutter of the craft equipment is in the changing state, that is, when the cutting force of the cutter of the craft equipment is a dynamic cutting force, the measurement accuracy of cutting force data is high, and results of the data are accurate. Therefore, when the cutting force is in the changing state, the calculated torque mapping coefficients between the cutting force of the cutter and the shaft torques of the servo motors are more accurate, and the data are more realistic and reliable.

In the embodiment of the present disclosure, according to an analysis based on the law of conservation of moment of momentum, the physical mapping relationships between the cutting force of the cutter and the shaft torques of the servo motors, respectively, may be obtained. The mapping relationship between the output torque of the first servo motor and the main cutting force and the radial thrust force of the cutting force of the cutter of the craft equipment may be determined, and the mapping relationship between the output torque of the second servo motor and the axial thrust force of the cutting force of the cutter of the craft equipment may be determined.

The torque mapping coefficients described in the present disclosure are mapping coefficients determined according to the physical mapping relationships between the cutting force of the cutter and the shaft torques of the servo motors.

The first torque mapping coefficient described in the present disclosure may represent the torque mapping coefficients between the torque data of the first servo motor, and the main cutting force data and the radial thrust force data of the cutting force data of the cutter of the craft equipment, respectively. The second torque mapping coefficient may represent the torque mapping coefficient between the torque data of the second servo motor and the axial thrust force data of the cutting force data of the cutter of the craft equipment.

The second cutting force data described in the present disclosure refers to the cutting force data obtained in the case that the cutting force of the cutter of the craft equipment is in the changing state. Since the cutting force is in the changing state, multiple sets of second cutting force data may be obtained.

The third torque data described in the present disclosure refers to the shaft torque data of the first servo motor obtained in the case that the cutting force of the cutter of the craft equipment is in the changing state. Since the cutting force is in the changing state, multiple third torque data may be monitored in real time.

The fourth torque data described in the present disclosure refers to the shaft torque data of the second servo motor obtained in the case that the cutting force of the cutter of the craft equipment is in the changing state. Similarly, since the cutting force is in the changing state, multiple fourth torque data may be monitored in real time.

In the embodiment of the present disclosure, the first torque mapping coefficient and the second torque mapping coefficient may be obtained based on the physical mapping relationships between the cutting force of the cutter and the shaft torques of the servo motors respectively, according to analyses and calculations performed on the multiple measured data sets, each of which includes the second cutting force data of the cutter of the craft equipment and the third torque data and the fourth torque data.

The first cutting force compensation data described in the present disclosure refers to compensation data of the main cutting force data and radial thrust force data of the first cutting force data. The second cutting force compensation data refers to compensation data of the axial thrust force data of the first cutting force data.

In some embodiments, based on the physical mapping relationships between the cutting force of the cutter and the shaft torques of the servo motors respectively, the first torque mapping coefficient and the second torque mapping coefficient may be calculated. The first cutting force compensation data may be calculated and obtained according to the first torque mapping coefficient and the first torque data, and the second cutting force compensation data may be calculated and obtained according to the second torque mapping coefficient and the second torque data.

At step S3, the first cutting force data is corrected based on the first cutting force compensation data and the second cutting force compensation data to obtain target cutting force data.

In some embodiments, the target cutting force data described in the present disclosure refers to cutting force data obtained after correcting the first cutting force data.

In the embodiment of the present disclosure, the main cutting force data and radial thrust force data of the first cutting force data are corrected according to the first cutting force compensation data, and the axial thrust force of the first cutting force data is corrected according to the second cutting force compensation data, thereby finishing correcting the first cutting force data and obtaining the target cutting force data.

The first cutting force data is corrected by the first cutting force compensation data and the second cutting force compensation data, thereby effectively improving the measurement accuracy of the cutting force data in the stable state.

In the method provided by the embodiment of the present disclosure, based on the fact that the piezoelectric sensor is sensitive to the increase in the force, in the case that the cutting force of the craft equipment is detected to be in the stable state, by detecting the shaft torque data of each servo motor, and according to the physical mapping relationship between the cutting force of the cutter and the shaft torque of each servo motor, the measured cutting force data and the torque data of the servo motor are coupled and solved to determine the first torque mapping coefficient and the second torque mapping coefficient that are numerically reliable. Thus, based on the first cutting force data of the cutter of the craft equipment and the first torque data of the first servo motor and the second torque data of the second servo motor, which are obtained in the case that the craft equipment cutting force is in the stable state, the actual first cutting force compensation data may be obtained according to the first torque mapping coefficient and the first torque data, and the actual second cutting force compensation data is obtained according to the second torque mapping coefficient and the second torque data. Then, based on the first cutting force compensation data and the second cutting force compensation data, the first cutting force data actually measured in the stable state is corrected to obtain the accurate and real cutting force, thereby improving the measurement accuracy of the cutting force data in the stable state, which is beneficial to optimization of the cutting process, thereby improving the working efficiency of the cutting machine tool.

In some embodiments, before obtaining the first cutting force data of the cutter of the craft equipment, the first torque data of the first servo motor and the second torque data of the second servo motor, following steps are further included.

A variation of the cutting force data of the cutter of the craft equipment is obtained.

In the case that the variation of the cutting force data is not less than a preset threshold, it is determined that the cutting force of the cutter of the craft equipment is in the changing state.

In another case that the variation of the cutting force data is less than the preset threshold, it is determined that the cutting force of the cutter of the craft equipment is in the stable state.

In some embodiments, the variation of the cutting force data described in the present disclosure refers to the variation of the cutting force data determined by calculating a difference between the cutting force obtained at the current time point and the cutting force obtained at the previous time point.

The preset threshold described in the present disclosure refers to the preset threshold of variation of the cutting force, and the state of the cutting force of the cutter of the craft equipment is determined based on the preset threshold.

In some embodiments, the state of the cutting force of the cutter of the craft equipment is determined by the preset threshold. If the variation of the cutting force data of the cutter of the craft equipment is not less than the preset threshold, it may be determined that the cutting force of the cutter of the craft equipment is in the changing state.

If the variation of the cutting force data of the cutter of the craft equipment is less than the preset threshold, it is determined that the cutting force of the cutter of the craft equipment is in the stable state.

Based on the characteristic of the piezoelectric sensor system arranged inside the craft equipment being sensitive to the increase in the force, the method of the embodiment of the present disclosure accurately judges the state of the cutting force of the cutter of the craft equipment via the preset threshold, thereby facilitating acquisition of the cutting force data and the torque data of the servo motors in different states, and facilitating calculation of subsequent compensations for the cutting force.

In some embodiments, after determining that the cutting force of the cutter of the craft equipment is in the changing state in the case that the variation of the cutting force data is not less than the preset threshold, the method further includes following steps.

In the case that the cutting force of the cutter of the craft equipment is in the changing state, multiple measured data sets are obtained, each of the multiple measured data sets includes the second cutting force data of the cutter of the craft equipment, the third torque data of the first servo motor and the fourth torque data of the second servo motor.

Based on the second cutting force data and the third torque data in each of the multiple measured data sets, the first torque mapping coefficient is determined.

Based on the second cutting force data and the fourth torque data in each of the multiple measured data sets, the second torque mapping coefficient is determined.

In some embodiments, in the case that the cutting force of the cutter of the craft equipment is in the changing state, the magnitude of the cutting force of the cutter of the craft equipment is changing all the time, and at this time, the shaft torque of the servo motor is also changing all the time. Therefore, the multiple different measured data sets may be obtained, and each of the multiple different measured data sets includes the second cutting force data of the cutter of the craft equipment, the third torque data of the first servo motor, and the fourth torque data of the second servo motor. In the same measured data set, the second cutting force data of the cutter of the craft equipment, the third torque data of the first servo motor, and the fourth torque data of the second servo motor are all measured at the same time.

In the embodiment of the present disclosure, the first servo motor may be a spindle motor in a spindle drive system of the cutting machine tool, and is configured to drive the spindle to drive the workpiece to rotate. The spindle drive system of the cutting machine tool includes the first servo motor, the spindle, a coupling, a chuck, a workpiece, etc. According to the law of conservation of moment of momentum, the output torque of the servo motor is balanced with a torque, which is generated by the cutting force and a moment of inertia of the drive system and a rotational friction force. The spindle bearing is usually assembled by two back-to-back angular-contact ball bearings, and the friction force thereof includes a sticky friction, a transitional friction, and a dynamic friction, and the calculation of the friction force is rather complicated. Considering that the cutting force is measured in a stable processing state, the friction force in the present disclosure is simplified by only considering the dynamic friction, and a relationship between the output torque of the spindle and the cutting force is:

Tₘ=F_{c}×R+I×α+Tₐ+μ×Fₚ×R (1)

Tₘ represents an actual torque of the first servo motor, F_{c} represents the main cutting force, Fₚ represents the radial thrust force, R represents a radius of the workpiece, I represents a moment of inertia on the spindle, α represents an angular acceleration of the spindle, and Tₐ represents an initial rotational friction force moment of the spindle, μ represents a dynamic friction coefficient of the spindle bearing.

It may be known from the equation (1) that when the diameter of the workpiece is constant and the spindle is moving at a constant speed, the relationship between the output torque of the spindle motor, and the main cutting force and the radial thrust force may be simplified as:

Tₘ=a₁×F_{c}+b₁×Fₚ+c₁ (2)

where, a₁, b₁, and c₁ are approximately constants.

In the embodiment of the present disclosure, the second servo motor may be the Z-directional feed motor in the feed shaft drive system of the cutting machine tool, and is configured to drive the feed shaft to drive the cutter of the craft equipment to move in the Z direction. The feed shaft drive system of the cutting machine tool includes the second servo motor, a ball screw, a guide rail, etc. The torque of the second servo motor is outputted through the ball screw. According to the law of conservation of moment of momentum, the output torque of the second servo motor is balanced with a torque generated by a thrust of the ball screw, the cutting force, the moment of inertia of the drive system, and the rotational friction force. The relationship between the output torque of the second servo motor and the cutting force is:

$${T}_{f} = \frac{( {F}_{f} + μ \times \sqrt{{( m g )}^{2} + {F}_{p}^{2} + {F}_{C}^{2}} ) \times L}{i \times 2 π η} + I \times α + {T}_{a} \qquad ( 3 )$$

Where, T_{f} represents an actual torque of the second servo motor, i represents a reduction ratio, F_{f} represents the axial thrust force, μ represents a friction coefficient between a cutter magazine table and a guiding member, m represents a mass of a load on a screw shaft (namely, a mass of the cutter magazine table), g is 9.8 m/s², L represents a lead of the screw, η represents an efficiency of the screw, I represents the moment of inertia on the feed shaft, α represents an angular acceleration of the feed shaft, and Tₐ represents an initial rotational friction force moment on the feed shaft.

Since Fₚ and F_{c} are far less than a weight of the cutter magazine table, influences of Fₚ and F_{c} on the torque of the second servo motor may be ignored. At present, most cutting machine tools have no external gear deceleration, so i may be regarded as 1. It may be seen from the equation (3) that when the cutting is performed at a constant speed, and in the case that the mass of the cutter magazine table remains unchanged, the relationship between the output torque of the second servo motor and the axial thrust force may be simplified as:

T_{f}=A₁×F_{f}+B₁ (4)

Where, A₁ and B₁ are approximately constants.

In the embodiment of the present disclosure, a real-time transmission may be performed by setting process data object (PDO) parameters, to acquire the shaft torque data of the servo motor in real time.

In some embodiments, when the cutting force of the cutter of the craft equipment is in the changing state, multiple measured data sets are obtained, and each of the multiple measured data sets includes the second cutting force data {F_{ci}, Fₚᵢ, F_{fi}} of the cutter of the craft equipment, the third torque data Tₘᵢ of the first servo motor, and the fourth torque data T_{fi} of the second servo motor, where i=1, 2, . . . , etc. Exemplarily, multiple measured data sets are {{F_{c1}, Fₚ₁, F_{f1}}, Tₘ₁, T_{f1}}, {{F_{c2}, Fₚ₂, F_{f2}}, Tₘ₂, T_{f2}} . . . , etc. Where {{F_{c1}, Fₚ₁, F_{f1}}, Tₘ₁, T_{f1}} are data measured at one same time, and {{F_{c2}, Fₚ₂, F_{f2}}, Tₘ₂, T_{f2}} are data measured at another same time.

Based on the physical mapping relationship of the cutter cutting force and the shaft torque of the servo motor, that is, based on the equation (2) above, an optimal calculation is performed for mapping coefficients according to each main cutting force data and radial thrust force data {Fₚᵢ, F_{ci}} of each second cutting force data and each third torque data Tₘᵢ to determine the first torque mapping coefficient.

Similarly, based on the equation (4) above, an optimal calculation may be performed for mapping coefficients according to each axial thrust force data F_{fi} of each second cutting force data and each fourth torque data T_{fi} to determine the second torque mapping coefficient.

In the method of the embodiment of the present disclosure, based on the characteristic of the piezoelectric sensor being sensitive to the increase in the force, in the case that the cutting force of the cutter of the craft equipment is in the changing state, the cutting force data of the cutter of the craft equipment and the torque data of each servo motor are obtained. Based on the physical mapping relationship between the cutting force of the cutter and the shaft torque of each servo motor, the measured cutting force data and the torque data of each servo motor are coupled and solved, thereby effectively determining numerically reliable first torque mapping coefficient and second torque mapping coefficient, so as to provide reliable calculation data for the subsequent compensation correction for the cutting force.

In some embodiments, the determining the first torque mapping coefficient based on the second cutting force data and the third torque data in each of the multiple measured data sets includes following steps.

Multiple sets of third torque mapping coefficients are determined according to the third torque data, and the second main cutting force data and the second radial thrust force data of the second cutting force data in each of the multiple measured data sets.

A calculation of least squares fitting is performed for the multiple sets of third torque mapping coefficients to obtain the first torque mapping coefficient.

In some embodiments, the second main cutting force data described in the present disclosure refers to the main cutting force component data of the second cutting force data, and the second radial thrust force data refers to the radial thrust force component data of the second cutting force data.

The third torque mapping coefficient described in the present disclosure refers to the torque mapping coefficient, which is obtained by calculating based on the physical mapping relationship between the cutting force of the cutter of the craft equipment and the shaft torque of the servo motor, and according to the second main cutting force data and the second radial thrust force data of the second cutting force data, and the third torque data.

In the embodiment of the present disclosure, a set of third torque mapping coefficients may be obtained according to the equation (2) above, and according to the third torque data, and the second main cutting force data and the second radial thrust force data of the second cutting force data in a measured data set. Therefore, multiple sets of third torque mapping coefficients {aᵢ, bᵢ, cᵢ}, where i=1, 2, . . . , etc., are obtained by calculating according to the third torque data Tₘᵢ, the second main cutting force data and the second radial thrust force data {F_{ci}, Fₚᵢ} in each measured data set.

Exemplarily, according to actual calculation requirements, ten data sets may be measured, namely, i=10. Ten sets of third torque mapping coefficients {aᵢ, bᵢ, cᵢ}, where i=1, 2, . . . , 10, are obtained by calculating according to the above equation (2), and according to ten third torque data, and the main cutting force data and the radial thrust force data in ten sets of second cutting force data in the ten measured data sets.

In some embodiments, the optimization calculation for the mapping coefficients is performed for the ten sets of third torque mapping coefficients. For example, the method of least squares fitting may be used to calculate the optimal set of coefficients {a, b, c}, that is, the first torque mapping coefficient may be obtained.

In the method of the embodiment of the present disclosure, the multiple sets of third torque mapping coefficients are determined according to the second main cutting force data and the second radial thrust force data in the multiple sets of second cutting force data, and the multiple third torque data of the first servo motor. Based on the method of least squares fitting performed for the multiple sets of torque mapping coefficients, the optimal torque mapping coefficient is calculated to ensure the accuracy of the torque mapping coefficients among the second main cutting force data, the second radial thrust force data and the shaft torque of the first servo motor, thereby ensuring the reliability of subsequent correction results of the main cutting force data and the radial thrust force data.

In some embodiments, the determining the second torque mapping coefficient based on the second cutting force data and the fourth torque data in each measured data set includes following steps.

Multiple sets of fourth torque mapping coefficients are determined according to the fourth torque data and the second axial thrust force data of the second cutting force data in each measured data set.

The calculation of least squares fitting is performed for the multiple sets of fourth torque mapping coefficients to obtain the second torque mapping coefficient.

In some embodiments, the second axial thrust force data described in the present disclosure refers to component force data of the axial thrust force of the second cutting force data.

The fourth torque mapping coefficient described in the present disclosure refers to the torque mapping coefficient obtained by calculating according to the physical mapping relationship between the cutting force of the cutter of the craft equipment and the shaft torque of the second servo motor, and according to the second axial thrust force data of the second cutting force data and the fourth torque data.

In the embodiment of the present disclosure, a set of fourth torque mapping coefficients may be obtained according to the equation (4) above, and according to the fourth torque data and the second axial thrust force data of the second cutting force data in a measured data set. Therefore, multiple sets of fourth torque mapping coefficients {Aᵢ, Bᵢ}, where i=1, 2, . . . , etc., may be obtained by calculating according to the fourth torque data T_{fi} and the second axial thrust force data F_{fi} in each measured data set.

Exemplarily, according to actual calculation requirements, eight data sets may be measured, that is, i=8. Eight sets of fourth torque mapping coefficients {Aᵢ, Bᵢ}, where i=1, 2, . . . , 8, are obtained by calculating according to the equation (2) above, and according to eight fourth torque data and the axial thrust force data in eight sets of second cutting force data.

In some embodiments, the optimization calculation for the mapping coefficients of eight sets of fourth torque mapping coefficients may be performed by the method of the least squares fitting, and a set of optimal coefficients {A, B} may be calculated, that is, the second torque mapping coefficient may be obtained.

In the method of the embodiment of the present disclosure, multiple sets of fourth torque mapping coefficients are determined according to the second axial thrust force data of the multiple sets of second cutting force data and multiple fourth torque data of the second servo motor, and a fitting calculation is performed for the multiple sets of fourth torque mapping coefficients based on the method of least squares fitting to calculate the optimal torque mapping coefficients, thereby ensuring the accuracy of the torque mapping coefficients between the second axial thrust force and the shaft torque of the second servo motor, and ensuring the reliability of the subsequent correction results of the axial thrust force data.

In some embodiments, the first cutting force data includes the first main cutting force data, the first radial thrust force data and the first axial thrust force data, and the correcting the first cutting force data based on the first cutting force compensation data and the second cutting force compensation data to obtain the target cutting force data includes the following steps.

Based on the main cutting force compensation data in the first cutting force compensation data, the first main cutting force data is corrected to obtain target main cutting force data.

Based on the radial thrust force compensation data in the first cutting force compensation data, the first radial thrust force data is corrected to obtain target radial thrust force data.

Based on the second cutting force compensation data, the first axial thrust force data is corrected to obtain target axial thrust force data.

The target cutting force data is obtained according to the target main cutting force data, the target radial thrust force data and the target axial thrust force data.

In some embodiments, the first cutting force data described in the present disclosure includes the first main cutting force data F_{c0}, the first radial thrust force data Fₚ₀, and the first axial thrust force data F_{f0}.

The target main cutting force data described in the present disclosure refers to the corrected first main cutting force data, the target radial thrust force data refers to the corrected first radial thrust force data, and the target axial thrust data refers to the data obtained by correcting the first axial thrust force data.

In the embodiment of the present disclosure, according to the equation (2), and based on the first torque mapping coefficients {a, b, c} and the first torque data Tₘ, the main cutting force compensation data F_{cn} and the radial thrust force compensation data Fₚₙ of the first cutting force compensation data may be obtained. In the same way, according to the equation (4), and based on the second torque mapping coefficients {A, B} and the second torque data T_{f}, the second cutting force compensation data, namely the axial thrust force compensation data F_{fn}, may be obtained.

In some embodiments, after the main cutting force compensation data F_{cn} is calculated, the value of the first main cutting force data F_{c0} is adjusted to the value of the main cutting force compensation data F_{cn} to obtain the target main cutting force data F_{cc}, and the value of the target main cutting force data F_{cc} is the same as the value of the main cutting force compensation data F_{cn}, so that the correction of the first main cutting force is realized.

Similarly, after the radial thrust force compensation data Fₚₙ is calculated, the value of the first radial thrust force data Fₚ₀ is adjusted to the value of the radial thrust force compensation data Fₚₙ, thereby obtaining the target radial thrust force data Fₚₚ, and the value of the target radial thrust force data Fₚₚ is the same as the value of the radial thrust force compensation data Fₚₙ, so that the correction of the first radial thrust force data is realized. After the axial thrust force compensation data F_{fn} is calculated, the value of the first axial thrust force F_{f0} is adjusted to the value of the axial thrust force compensation data F_{fn}, thereby obtaining the target axial thrust force data F_{ff}, and the value of the target axial thrust force data F_{ff} is the same as the value of the axial thrust force compensation data F_{fn}, so that the correction of the first axial thrust force data is realized.

In some embodiments, the target cutting force data F={F_{cc}, Fₚₚ, F_{ff}} may be obtained according to the target main cutting force data F_{cc}, the target radial thrust force data Fₚₚ, and the target axial thrust force data F_{ff}.

In the method of the embodiment of the present disclosure, based on the accuracy of the first torque mapping coefficient and the second torque mapping coefficient obtained in the case that the cutting force of the cutter of the craft equipment is in the changing state, the first cutting force compensation data and the second cutting force compensation data may be accurately calculated according to the physical mapping relationship between the cutting force and the shaft torque of the servo motor in the case that the cutting force of the cutter of the craft equipment is in the stable state, and then the actually measured first cutting force data is compensated and corrected according to the first cutting force compensation data and the second cutting force compensation data to obtain the accurate target cutting force data, which may effectively improve the measurement accuracy of the cutting force data in the stable state.

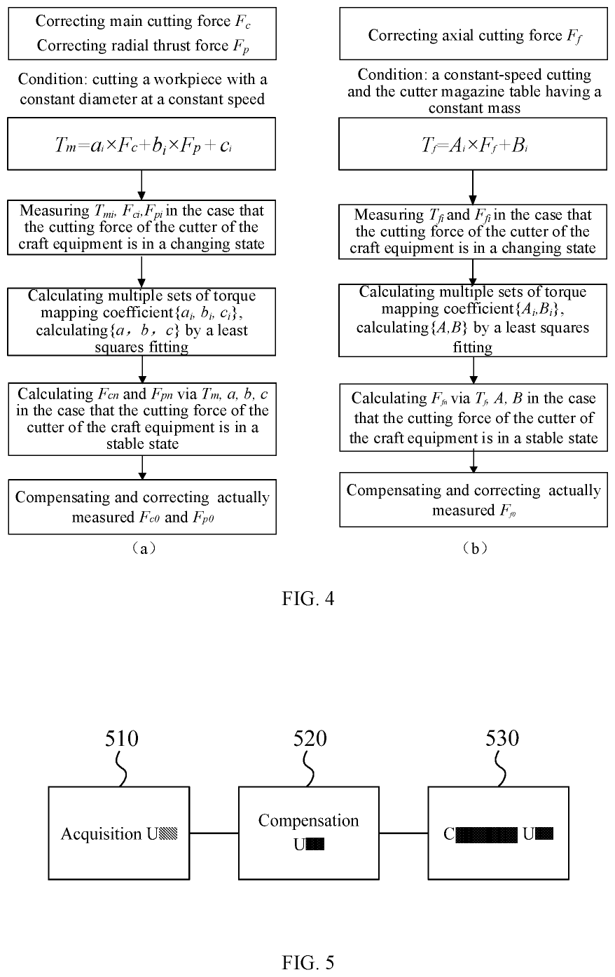

FIG. 4 shows schematic flowcharts of compensating and correcting the cutting force provided by the present disclosure. As shown in FIG. 4, a flowchart (a) on the left side of FIG. 4 is the schematic flowchart of compensating and correcting the main cutting force and the radial thrust force, and a flowchart (b) on the right side of FIG. 4 is the schematic flowchart of compensating and correcting the axial thrust force.

As shown in the flowchart (a) of FIG. 4, in the case of cutting a workpiece with a constant diameter at a constant speed, the first servo motor drives the spindle to rotate at a constant speed. The main cutting force and the radial thrust force are measured before the cutter of the craft equipment contacts the workpiece. During an initial time period after the cutter contacts the workpiece, the cutting force of the cutter of the craft equipment is in the changing state and is a dynamic cutting force. At this time, multiple sets of second cutting force data {F_{ci}, Fₚᵢ} of the cutter of the craft equipment and multiple third torque data Tₘᵢ of the first servo motor may be measured. Based on the equation (2) representing the physical mapping relationship between the cutting force of the cutter of the craft equipment and the torque of the first servo motor, the measured multiple sets of second cutting force data {F_{ci}, Fₚᵢ} and the multiple third torque data Tₘᵢ are substituted into the equation (2) to obtain the multiple sets of torque mapping coefficients {aᵢ, bᵢ, cᵢ}, and then the method of least squares fitting is performed to calculate the optimal set of torque mapping coefficients {a, b, c}. When the cutting force of the cutter of the craft equipment is in the stable state and is a cutting force partial to static state, the main cutting force data F_{c0} and the radial thrust force data Fₚ₀ of the first cutting force data of the cutter of the craft equipment, and real-time torque data Tₘ of the first servo motor are measured. Tₘ and {a, b, c} are substituted into the equation (2) to calculate the cutting force compensation data F_{cn} and Fₚₙ, and the first main cutting force data F_{c0} and the first radial thrust force data Fₚ₀ of the first cutting force data may be corrected according to the cutting force compensation data F_{cn} and Fₚₙ, respectively.

As shown in the flowchart (b) of FIG. 4, in the case of a constant-speed cutting and the cutter magazine table having a constant mass, the first servo motor drives the spindle to rotate at a constant speed, and the second servo motor drives the cutter of the craft equipment to move in the Z direction at a constant speed. The axial thrust force is measured before the cutter of the craft equipment contacts the workpiece. During the initial time period after the cutter contacts the workpiece, the cutting force of the cutter of the craft equipment is a dynamic cutting force. At this time, multiple second cutting force data F_{fi} of the cutter of the craft equipment and multiple fourth torque data T_{fi} of the second servo motor may be measured. Based on the equation (4), the measured multiple second cutting force data F_{fi} and multiple fourth torque data T_{fi} are substituted into the equation (4) to get multiple sets of torque mapping coefficients {Ai, Bi}, and then the least squares fitting is performed to calculate the optimal set of torque mapping coefficient {A, B}. When the cutting force of the cutter of the craft equipment is in the stable state and is a cutting force partial to static state, the axial thrust force F_{f0} of the first cutting force data of the cutter of the craft equipment and the real-time torque data T_{f} of the second servo motor are measured. T_{f} and {A, B} are substituted into the equation (4) to calculate the cutting force compensation data F_{fn}, and the first axial thrust force F_{f0} of the first cutting force data may be corrected according to the cutting force compensation data F_{fn}.

In method of the embodiment of the present disclosure, the high-frequency cutting force may be directly measured, and in the case of a low-frequency cutting partial static state, by externally detecting the shaft torque data of each servo motor to perform fitting, compensation and correction, which not only solves the problem of low measurement accuracy of the low-frequency cutting force partial to static state, but also realizes high-precision measurement of the high-frequency cutting force, thereby effectively guiding an adjustment of processing parameters of cutting, reducing wear of the cutter and cutting vibration, improving processing quality, and providing technology for an adaptive control for the cutting force of a numerical control machine.

A device for measuring a cutting force provided by the present disclosure will be described below. The device for measuring the cutting force described below and the method for measuring the cutting force described above may be referred to each other correspondingly.

FIG. 5 is schematic structural view showing a device for measuring a cutting force provided by the present disclosure, as shown in FIG. 5, the device includes an acquisition unit 510, a compensation unit 520, and a correcting unit 530.

The acquisition unit 510 is configured to, in a case that a cutting force of a craft equipment is detected to be in a stable state, obtain first cutting force data of a cutter of the craft equipment, first torque data of a first servo motor, and second torque data of a second servo motor. The first servo motor is configured to drive a workpiece to rotate, and the second servo motor is configured to drive the cutter of the craft equipment to contact the workpiece.

The compensation unit 520 is configured to generate first cutting force compensation data based on a first torque mapping coefficient and the first torque data, and generate second cutting force compensation data based on a second torque mapping coefficient and the second torque data. The first torque mapping coefficient and the second torque mapping coefficient are generated according to multiple measured data sets, and each measured data set includes the second cutting force data of the cutter of the craft equipment and the third torque data of the first servo motor and the fourth torque data of the second servo motor, which are obtained in the case that the cutting force of the cutter of the craft equipment is in a changing state.

The correcting unit 530 is configured to correct the first cutting force data based on the first cutting force compensation data and the second cutting force compensation data to obtain target cutting force data.

In the device for measuring cutting force provided by the embodiment of the present disclosure, based on the fact that the piezoelectric sensor is sensitive to the increase in the force, in the case that the cutting force of the craft equipment is detected to be in the stable state, by detecting the shaft torque data of each servo motor, and according to the physical mapping relationship between the cutting force of the cutter and the shaft torque of each servo motor, the measured cutting force data and the torque data of the servo motor are coupled and solved to determine the first torque mapping coefficient and the second torque mapping coefficient that are numerically reliable. Thus, based on the first cutting force data of the cutter of the craft equipment and the first torque data of the first servo motor and the second torque data of the second servo motor, which are obtained in the case that the craft equipment cutting force is in the stable state, the actual first cutting force compensation data may be obtained according to the first torque mapping coefficient and the first torque data, and the actual second cutting force compensation data is obtained according to the second torque mapping coefficient and the second torque data. Then, based on the first cutting force compensation data and the second cutting force compensation data, the first cutting force data actually measured in the stable state is corrected to obtain the accurate and real cutting force data, thereby improving the measurement accuracy of the cutting force data in the stable state, which is beneficial to optimization of the cutting process, thereby improving the working efficiency of the cutting machine tool.

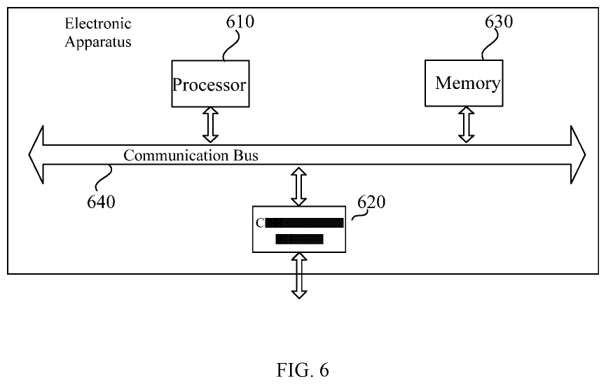

FIG. 6 is a schematic structural view showing an electronic apparatus provided by the present disclosure. As shown in FIG. 6, the electronic apparatus may include: a processor 610, a communication interface 620, a memory 630, and a communication bus 640. The processor 610, the communication interface 620, and the memory 630 communicate with each other through a communication bus 640. The processor 610 may call logic instructions in the memory 630 to execute the method for measuring cutting force provided by the above-mentioned embodiments, and the method includes following steps. In a case that a cutting force of the craft equipment is detected to be in a stable state, first cutting force data of a cutter of the craft equipment, first torque data of a first servo motor, and second torque data of a second servo motor are obtained. The first servo motor is configured to drive a workpiece to rotate, and the second servo motor is configured to drive the cutter of the craft equipment to contact the workpiece. First cutting force compensation data is generated based on a first torque mapping coefficient and the first torque data, and second cutting force compensation data is generated based on a second torque mapping coefficient and the second torque data. The first torque mapping coefficient and the second torque mapping coefficient are generated according to multiple measured data sets, and each of the multiple measured data sets includes the second cutting force data of the cutter of the craft equipment and the third torque data of the first servo motor and the fourth torque data of the second servo motor, which are obtained in the case that the cutting force of the cutter of the craft equipment is in a changing state. The first cutting force data is corrected based on the first cutting force compensation data and the second cutting force compensation data to obtain target cutting force data.

In addition, the above-mentioned logic instructions in the memory 630 may be implemented in the form of software functional units and may be stored in a computer-readable storage medium when being sold or used as an independent product. Based on this comprehension, the technical solutions or the part that contributes to the prior art or the part of the technical solutions of the present disclosure may be embodied in the form of a software product in essence. The computer software product is stored in a storage medium and includes several instructions, and is configured to cause a computer device (which may be a personal computer, a server, or a network device, etc.) to execute all or part of the steps of the methods described in various embodiments of the present disclosure. The aforementioned storage medium includes U disk, mobile hard disk, Read-Only Memory (ROM), Random Access Memory (RAM), magnetic disk, optical disk, or any other media that may store program codes.

In another aspect, the present disclosure also provides a computer program product. The computer program product includes a computer program, and the computer program may be stored on a non-transitory computer-readable storage medium. The computer program, when being executed by a processor, executes the method for measuring cutting force provided by the above methods, and the method includes following steps. In a case that a cutting force of the craft equipment is detected to be in a stable state, first cutting force data of a cutter of the craft equipment, first torque data of a first servo motor, and second torque data of a second servo motor are obtained. The first servo motor is configured to drive a workpiece to rotate, and the second servo motor is configured to drive the cutter of the craft equipment to contact the workpiece. First cutting force compensation data is generated based on a first torque mapping coefficient and the first torque data, and second cutting force compensation data is generated based on a second torque mapping coefficient and the second torque data. The first torque mapping coefficient and the second torque mapping coefficient are generated according to multiple measured data sets, and each of the multiple measured data sets includes the second cutting force data of the cutter of the craft equipment and the third torque data of the first servo motor and the fourth torque data of the second servo motor, which are obtained in the case that the cutting force of the cutter of the craft equipment is in a changing state. The first cutting force data is corrected based on the first cutting force compensation data and the second cutting force compensation data to obtain target cutting force data.

In yet another aspect, the present disclosure also provides a non-transitory computer-readable storage medium, on which a computer program is stored. The computer program, when being executed by a processor, performs the method for measuring cutting force provided by the above methods, and the method includes following steps. In a case that a cutting force of the craft equipment is detected to be in a stable state, first cutting force data of a cutter of the craft equipment, first torque data of a first servo motor, and second torque data of a second servo motor are obtained. The first servo motor is configured to drive a workpiece to rotate, and the second servo motor is configured to drive the cutter of the craft equipment to contact the workpiece. First cutting force compensation data is generated based on a first torque mapping coefficient and the first torque data, and second cutting force compensation data is generated based on a second torque mapping coefficient and the second torque data. The first torque mapping coefficient and the second torque mapping coefficient are generated according to multiple measured data sets, and each of the multiple measured data sets includes the second cutting force data of the cutter of the craft equipment and the third torque data of the first servo motor and the fourth torque data of the second servo motor, which are obtained in the case that the cutting force of the cutter of the craft equipment is in a changing state. The first cutting force data is corrected based on the first cutting force compensation data and the second cutting force compensation data to obtain target cutting force data.

The device embodiments described above are only illustrative. The units described as separate components may be physically separated or not, and the components displayed as units may be physical units or not, that is, they may be located in one place, or they may be distributed on a plurality of network units. Some or all of the units may be selected according to actual needs to achieve the objectives of the solutions of the embodiments. Those of ordinary skill in the art may understand and implement the solutions without creative efforts.

From the description of the above embodiments, those skilled in the art may clearly understand that each embodiment may be implemented by means of software and a necessary general hardware platform, and certainly may also be implemented by hardware. Based on this comprehension, the technical solutions or the part that contributes to the prior art or the part of the technical solutions of the present disclosure may be embodied in the form of a software product in essence. The computer software product is stored in a storage medium, such as ROM/RAM, magnetic disk, or optical disk, and includes several instructions for causing a computer device (which may be a personal computer, a server, or a network device, etc.) to perform the methods described in various embodiments or some parts of the embodiments.

Finally, it should be noted that the above embodiments are only used to illustrate but not limit the technical solutions of the present disclosure. Although the present disclosure has been described in detail with reference to the foregoing embodiments, those of ordinary skill in the art should understand that the technical solutions described in the foregoing embodiments may be modified, or some technical features thereof may be equivalently replaced, and these modifications or replacements will not make the essence of the corresponding technical solutions deviate from the spirit and scope of the technical solutions of the embodiments of the present disclosure.

What is claimed is:

1. A method for measuring a cutting force, comprising:
obtaining first cutting force data of a cutter of a craft equipment, first torque data of a first servo motor, and second torque data of a second servo motor in a case that the cutting force of the craft equipment is detected to be in a stable state; the first servo motor being configured to drive a workpiece to rotate; the second servo motor being configured to drive the cutter of the craft equipment to contact the workpiece;
generating first cutting force compensation data based on a first torque mapping coefficient and the first torque data; generating second cutting force compensation data based on a second torque mapping coefficient and the second torque data; the first torque mapping coefficient and the second torque mapping coefficient being generated according to multiple sets of second cutting force data of the cutter of the craft equipment, multiple sets of third torque data of the first servo motor and multiple sets of fourth torque data of the second servo motor; the multiple sets of second cutting force data of the cutter of the craft equipment, the multiple sets of third torque data of the first servo motor, and the multiple sets of fourth torque data of the second servo motor being obtained in a case that the cutting force of the cutter of the craft equipment is in a changing state; the first cutting force data being cutting force data when the cutting force of the cutter of the craft equipment is in the stable state; the second cutting force data being cutting force data when the cutting force of the cutter of the craft equipment is in the changing state; and the cutting force data comprising main cutting force data, radial thrust force data, and axial thrust force data; and
correcting the first cutting force data based on the first cutting force compensation data and the second cutting force compensation data to obtain target cutting force data.

2. The method for measuring the cutting force according to claim 1, wherein before the obtaining the first cutting force data of the cutter of the craft equipment, the first torque data of the first servo motor, and the second torque data of the second servo motor, the method further comprises:
obtaining a variation of the cutting force data of the cutter of the craft equipment; and
determining that the cutting force of the cutter of the craft equipment is in the changing state in a case that the variation of the cutting force data is not less than a preset threshold, or
determining that the cutting force of the cutter of the craft equipment is in the stable state in a case that the variation of the cutting force data is less than a preset threshold.

3. The method for measuring the cutting force according to claim 2, wherein after the determining that the cutting force of the cutter of the craft equipment is in the changing state in the case that the variation of the cutting force data is not less than the preset threshold, the method further comprises:
obtaining multiple measured data sets in the case that the cutting force of the cutter of the craft equipment is in the changing state, each of the multiple measured data sets comprising the second cutting force data of the cutter of the craft equipment, the third torque data of the first servo motor, and the fourth torque data of the second servo motor;
determining the first torque mapping coefficient based on the second cutting force data and the third torque data in each of the multiple measured data sets; and
determining the second torque mapping coefficient based on the second cutting force data and the fourth torque data in each of the multiple measured data sets;

4. The method for measuring the cutting force according to claim 3, wherein the determining the first torque mapping coefficient based on the second cutting force data and the third torque data in each of the multiple measured data sets, comprises:
determining multiple sets of third torque mapping coefficients according to the third torque data, and the second main cutting force data and the second radial thrust force data of the second cutting force data in each of the multiple measured data sets; and
performing a calculation of least squares fitting for the multiple sets of third torque mapping coefficients to obtain the first torque mapping coefficient.

5. The method for measuring the cutting force according to claim 3, wherein the determining the second torque mapping coefficient based on the second cutting force data and the fourth torque data in each of the multiple measured data sets, comprises:
determining multiple sets of fourth torque mapping coefficients according to the fourth torque data and the second axial thrust force data of the second cutting force data in each of the multiple measured data sets; and
performing a calculation of least squares fitting for the multiple sets of fourth torque mapping coefficients to obtain the second torque mapping coefficient.

6. The method for measuring the cutting force according to claim 1, wherein the first cutting force data comprises first main cutting force data, first radial thrust force data and first axial thrust force data, and the correcting the first cutting force data based on the first cutting force compensation data and the second cutting force compensation data to obtain the target cutting force data comprises:
correcting the first main cutting force data based on main cutting force compensation data in the first cutting force compensation data to obtain target main cutting force data;
correcting the first radial thrust force data based on radial thrust force compensation data in the first cutting force compensation data to obtain target radial thrust force data;
correcting the first axial thrust force data based on the second cutting force compensation data to obtain target axial thrust force data; and
obtaining the target cutting force data according to the target main cutting force data, the target radial thrust force data, and the target axial thrust force data.

7. The method for measuring the cutting force according to claim 1, wherein the first torque data of the first servo motor is shaft torque data of the first servo motor obtained in real time; and
the second torque data of the second servo motor is shaft torque data of the second servo motor obtained in real time in the case that the cutting force of the cutter of the craft equipment is in the stable state.

8. The method for measuring the cutting force according to claim 1, wherein:
the main cutting force data, the radial thrust force data, and the axial thrust force data are perpendicular to each other;
the main cutting force is consistent with a direction of a main cutting speed;
the radial thrust force is in a base plane and perpendicular to a Z-directional feeding direction of a movement of the cutter driven by the second servo motor; and
the axial thrust force is in the base plane and parallel to a feeding direction of the cutter.

9. A device for measuring cutting force, comprising:
an acquisition unit, configured to obtain first cutting force data of a cutter of craft equipment, first torque data of a first servo motor, and second torque data of a second servo motor in a case that the cutting force of the craft equipment is detected to be in a stable state, wherein the first servo motor is configured to drive a workpiece to rotate, and the second servo motor is configured to drive the cutter of the craft equipment to contact the workpiece;
a compensation unit, configured to generate first cutting force compensation data based on a first torque mapping coefficient and the first torque data, and generate second cutting force compensation data based on a second torque mapping coefficient and the second torque data, wherein: the first torque mapping coefficient and the second torque mapping coefficient are generated according to multiple sets of second cutting force data of the cutter of the craft equipment, multiple sets of third torque data of the first servo motor, and multiple sets of fourth torque data of the second servo motor; the multiple sets of second cutting force data of the cutter of the craft equipment, the multiple sets of third torque data of the first servo motor, and the multiple sets of fourth torque data of the second servo motor are obtained in a case that the cutting force of the cutter of the craft equipment is in a changing state; the first cutting force data is cutting force data when the cutting force of the cutter of the craft equipment is in the stable state; the second cutting force data is cutting force data when the cutting force of the cutter of the craft equipment is in the changing state; and the cutting force data comprises main cutting force data, radial thrust force data, and axial thrust force data; and
a correcting unit, configured to correct the first cutting force data based on the first cutting force compensation data and the second cutting force compensation data to obtain target cutting force data.

10. An electronic apparatus, comprising a memory, a processor, and a computer program stored on the memory and executable in the processor, wherein the processor, when executing the computer program, performs steps of the method for measuring the cutting force according to claim 1.

11. A non-transitory computer-readable storage medium, on which a computer program is stored, wherein the computer program, when being executed by a processor, causes the processor to perform steps of the method for measuring the cutting force according to claim 1.

12. A computer program product, comprising a computer program, wherein the computer program, when being executed by a processor, causes the processor to perform steps of the method for measuring the cutting force according to claim 1.
